(19) United States
(12) Patent Application Publication
(10) Pub. No.: US 2003/0145200 A1
(43) Pub. Date: Jul. 31, 2003

(54) System and method for authenticating data transmissions from a digital scanner

(76) Inventor: Guy Eden, Tustin, CA (US)

Correspondence Address: David C. Ripma, Patent Counsel, Sharp Laboratories of America, Inc., 5750 NW Pacific Rim Boulevard, Camas, WA, 98607, US

(21) Appl. No.: 10/062,636

(22) Filed: Jan. 31, 2002

(51) Int. Cl. H04L 9/00

(52) U.S. Cl. 713/161

(57) ABSTRACT

A system and method are provided for authenticating data transmission between a network-connected digital scanner and a terminal. The method comprises: scanning a document at a digital scanner; signing the scanned document with a private key of a first asymmetric key-pair to create a first signature; transmitting the scanned document and first signature to a network-connected terminal; and, at the terminal, using a public key of the first key-pair to authenticate the transmitted document.

Typically, signing the scanned document with a private key of a first asymmetric key-pair to create a first signature includes: creating a one-way hash function of the scanned document; and, encrypting the one-way hash function with the private key. Then, using a public key of the first key-pair to authenticate the transmitted scanned document includes: creating a one-way hash function of the transmitted document; decrypting the transmitted first signature with the public key; and, comparing the one-way hash function of the transmitted document to the decrypted signature. Some aspects of the method include the further steps of: at the digital scanner, establishing a user identity test, for example a PIN number, associated with the terminal; and submitting proof of user identity when a document is to be transmitted. Then, the scanned document and signature are transmitted in response to passing the user identity test, for example inputting the PIN number.

### BACKGROUND OF THE INVENTION

1. Field of the Invention

This invention generally relates to network security and, more particularly, to a system and method of enhancing the authentication means available for documents that are processed with a digital scanner and transmitted to a network-connected terminal.

2. Description of the Related Art

As noted in U.S. Pat. No. 6,314,521 (Derby), there are many different types of security issues that arise in a network environment. Some files must be encrypted at the sending end and decrypted at the receiving end to help ensure that the file contents are not intercepted by an unauthorized entity during the transmission. This security feature, along with other security features that are known, helps guarantee that a file has not been tampered with or can ensure the identity of the sender or receiver.

Conventional (symmetric) cryptography requires that the sender and receiver of an encrypted message share the same secret key. The same key is used to both scramble (encrypt) and unscramble (decrypt) information. In 1977, the National Bureau of Standards approved a block cipher algorithm referred to as the Data Encryption Standard (DES). Binary-coded data is protected by using the DES algorithm in conjunction with a key. An authorized user must have the key that was used to encipher the data in order to decipher it. Unauthorized recipients of the ciphered in-formation content who may know the DES algorithm, but who do not know the key cannot decipher the information content.

One major problem with this method is the key exchange topology. Sharing the key requires that one party send it to the other. However, since most communication networks cannot be trusted, the key itself must be encrypted. If it is sent in the clear, there is a danger that someone eavesdropping on the line could get the key and then be able to decode messages sent between the two parties. Thus, the security of the contents depends upon the security of the key. As such, the key has to be distributed to authorized users in a secure manner. Public key cryptography cannot only be used to ensure the privacy of transmitted messages, but it can also be used in other applications, including digital signatures.

For ensuring the privacy of transmitted messages, public key cryptography does solve many of the problems, discussed above, of securely distributing the key used in conventional cryptography. Public key cryptography is based on two keys, a private key and a public key, that work together. A person's public key is openly made available to others, while their private key is kept secret. One key is used for ciphering and the other key is used to decipher information content. For each encryption key there is a corresponding, but separate and distinct, decryption key. Messages encrypted with a person's public key can only be decrypted with that person's private key. Even if one key is known, it is not feasible to compute the other key.

In a public key system, it is possible to communicate privately without transmitting any secret key. For example, the encryption key for each user is made public by being distributed or published. Anyone desiring to communicate in private with a recipient merely encrypts the message under the recipient's public key. Only the recipient, who retains the secret decrypting key, is able to decipher the transmitted message.

A combination of conventional cryptography and public key cryptography allows a secret key to be sent securely to an intended recipient. The sender encrypts a message with the secret key using the recipient's public key. The recipient then uses the recipient's private key to decrypt the message and to get the secret key for other transmissions. Since public key encryption is slower than secret key encryption, this approach allows subsequent transmissions to use the faster conventional secret key cryptography approach.

In these cryptographic systems, there is sometimes still a need to verify that the sender of a received message is actually the person named in the message. Digital signatures, which are based on public key cryptography, are used as a means to authenticate the sender of a message. A digital signature allows a digital message to be signed so that any receiver of a digitally signed electronic message can authenticate the sender of the message and verify the integrity of the signed message. That is, the recipient is assured that the message is received as sent, and that it is not a forgery.

To ensure that the original true sender sent the message, a process is used that is just the opposite of the one used to ensure the private communication using public key cryptography described above. For example, a user who has published a public key can digitally sign a message by encrypting the message, or a hash of it, with the user's private key before transmitting the message. Recipients of the message can verify the message or signature by decrypting it with the sender's public encryption key. This process is just the opposite of conventional cryptography in that the message is first encrypted by the sender using the sender's private key and decrypted by the recipient using the sender's public key. Anyone who has the sender's public encryption key can read the message or signature. Any such recipient is assured of the authentication of the creator of the message since only the sender having the secret private key could have created the message or signature. The recipient is also assured that the message has not been altered since it was first created and the digital signature was attached to it. Any recipient can authenticate the digital signature and verify the integrity of the message by using only the signer's public key.

In the above example, the digital signature was the encryption, using the sender's private key, of the message itself. In the Digital Signature Standard (ANSI X9.30 Part I) a person's digital signature is a fixed-length string of bits that are attached to an electronic message of any length. To create a fixed-length digital signature, a hashing function is used that converts a message of any length to the same fixed-length hash, or digest, of the message. The Secure Hash Algorithm (SHA) is a known hash function that is part of the Digital Signature Standard. This hash of a message is like a “fingerprint” in that it is practically impossible for two distinct messages to result in identical hashes. After creating a hash of the message, the sender's private key is applied to the hash to create the digital signature for the message. The digital signature is a function of both the message being signed and the signer's private key. As long as the private key is kept secret, the digital signature cannot be created by anyone else.

Upon receipt of the digitally-signed message, the recipient uses the sender's public key to convert the digital signature to the hash that the sender computed. Next, the recipient applies the same hash function to the plain text message received and gets the hash of the received message. If the hash of the received message is identical to the hash obtained by using the sender's public key to convert the digital signature, then the recipient has authenticated the sender's digital signature and verified the integrity of the signed message.

Currently, there is a significant security exposure in scanners attached to networks in that there is no way to authenticate that a scanner really exists at a specified network address. That is, software could be used to fool the system or a potential user into thinking that a scanner was at a network address, but print data sent to that address could be misappropriated by hostile software and used for other purposes. Although digital certificates are used in computing systems to authenticate parties who will trade information, currently secure scanners, i.e., scanners that are capable of authenticating themselves to a user or a foreign system, are nonexistent. Further, even if the sender's address could be verified, there is no convenient way to confirm that the document was not tampered with during transmission.

In pending application Ser. No. 09/944,684, entitled SYSTEM AND METHOD FOR USING A PROFILE TO ENCRYPT DOCUMENTS IN A DIGITAL SCANNER, attorney docket No. SLA1086, filed on Aug. 31, 2001, invented by Guy Eden, and assigned to the same assignees as the instant invention, a method is provided for secure document transmission in a digital scanner by generating a password for a plurality of user groups; creating profiles having an address field and an encryption field; storing the profiles in a directory in response to the generated password; selecting a profile from the directory; scanning a document; encrypting the document in response to the encryption field of the selected profile; and, sending the encrypted document in response to the address field of the selected profile. However, this process does not address the authentication of the data transmission.

It would be advantageous if a means existed for authenticating the identity of a network-connected digital scanner from which documents are being received.

It would be advantageous if the integrity the documents being received from a network-connected scanner could be verified.

It would be advantageous if proof of receipt could be maintained for documents received from a network-connected scanner.

### SUMMARY OF THE INVENTION

The present invention utilizes digital signatures, to solve the authentication issues involving with a network-connected scanner. A digital signature is annexed to the image (scanned document) that can later be used to authenticate the image. More specifically, the present invention introduces a method for assuring authentication, integrity, and non-repudiation in the process of transmitting digital documents in a network environment, using a digital scanner.

With respect to authentication, the present invention makes it possible for the receiver of a scanned document to ascertain its origin. This prevents an intruder from masquerading as someone else. With respect to integrity, the invention makes it possible for the receiver of the document to verify that it has not been modified in transit. An intruder cannot substitute a false image for a legitimate one. With respect to non-repudiation, a sender cannot falsely deny at a later date that they sent the message.

Accordingly, a method is provided for authenticating data transmission between a network-connected digital scanner and a terminal. The method comprises: scanning a document at a digital scanner; signing the scanned document with a private key of a first asymmetric key-pair to create a first signature; transmitting the scanned document and first signature to a network-connected terminal; and, at the terminal, using a public key of the first key-pair to authenticate the transmitted document.

Typically, signing the scanned document with a private key of a first asymmetric key-pair to create a first signature includes: creating a one-way hash function of the scanned document; and, encrypting the one-way hash function with the private key. Then, using a public key of the first key-pair to authenticate the transmitted scanned document includes: creating a one-way hash function of the transmitted document; decrypting the transmitted first signature with the public key; and, comparing the one-way hash function of the transmitted document to the decrypted signature.

The method further comprises: determining that the transmission originated from a digital scanner with an installed first key-pair private key; verifying that the scanned document has not been modified during transmission; and, saving a copy of the transmitted document and the transmitted first signature as proof that the transmitted document was received.

Some aspects of the method include the further steps of: at the digital scanner, establishing a user identity test, for example a PIN number, associated with the terminal; and submitting proof of the user identity when a document is to be transmitted. Then, the scanned document and signature are transmitted in response to passing the user identity test, for example inputting the PIN number.

Additional details of the above-described method and a system for authenticating data transmission are proved below.

### BRIEF DESCRIPTION OF THE DRAWINGS

FIG. 1 is a flowchart illustrating the present invention system for authenticating data transmission.

FIGS. 2a and 2b are flowcharts illustrating the present invention method for authenticating data transmission between a network-connected digital scanner and a terminal.

### DETAILED DESCRIPTION OF THE PREFERRED EMBODIMENTS

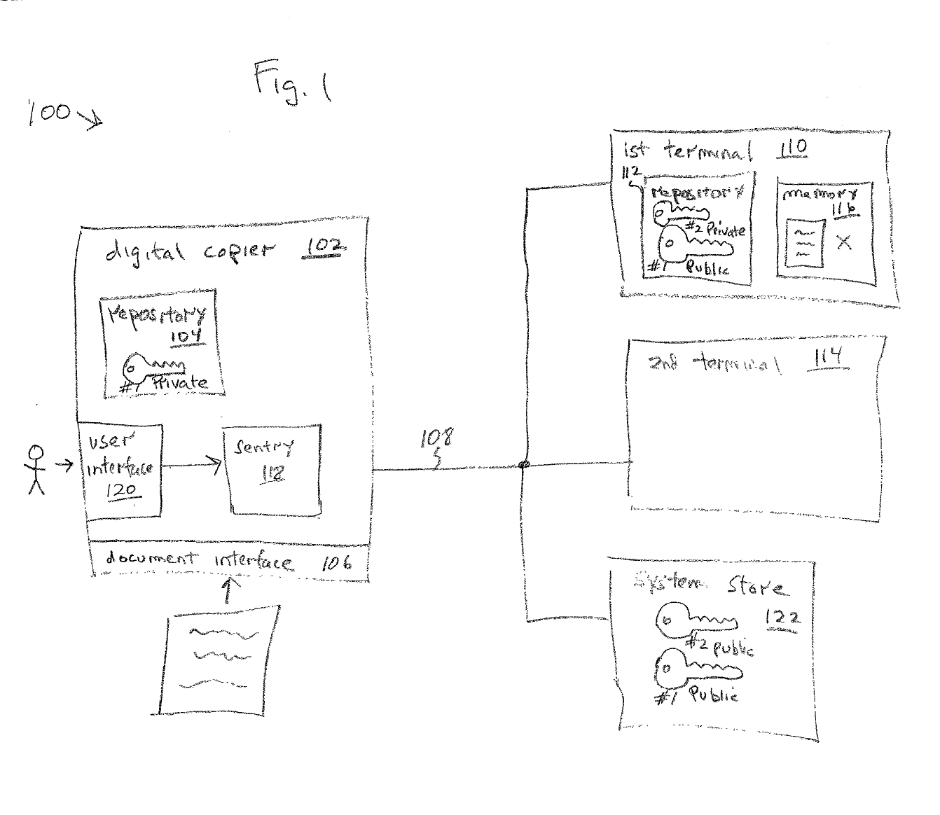

FIG. 1 is a flowchart illustrating the present invention system for authenticating data transmission. The system 100 comprises a digital scanner 102 having a repository 104 for a private key of a first asymmetric key-pair and an interface 106 for receiving documents. As used herein, the digital scanner 102 can also be a printer, fax, copier, or multifunctional peripheral (MFP) device. A digital scanner makes a digital record of the image it scans, records, or reproduces. The digital scanner 102 scans a submitted document and signs the scanned document with the private key to create a first signature. Then, the digital scanner 102 transmits the scanned document and first signature at an output on line 108. Line 108 represents a transmission medium that can be an Ethernet connection, local area network (LAN) line, a phoneline, a floppy disk, CD, smart card, or even a wireless channel, to name but a few possibilities. The present invention system 100 is not limited to any particular transmission medium.

The system 100 also comprises at least a first terminal 110 having a repository 112 for a public key of the first key-pair. The first terminal 110 has an input on line 108 to accept the transmitted document and the transmitted first signature from the digital scanner 102. The first terminal 110 can be a personal computer (PC), a workstation supported with software applications, or a web browser. If the first terminal 110 is a web browser, the digital scanner would include an interfacing web server (not shown). Also shown is a second terminal 114, however, the present invention system 100 is not limited to any particular number of terminals. The first terminal 110 uses the public key to authenticate the transmitted document.

More typically, the digital scanner 102 creates the first signature by generating a one-way hash function of the scanned document and encrypts the one-way hash function with the private key. Then, the first terminal 110 authenticates the transmitted scanned document by creating a one-way hash function of the transmitted document, decrypting the transmitted first signature with the public key, and comparing the one-way hash function of the transmitted document to the decrypted signature. If the one-way hash function matches the decrypted signature, then the document is authenticate.

Alternately, the digital scanner 102 encrypts the entire scanned document using the private key of the first key-pair. Likewise, the first terminal 110 authenticates the transmitted document by decrypting the transmitted item using the public key of the first key-pair. However, this process requires more processing on both ends of the transmission and a larger throughput (a bigger file).

The first terminal 110 uses the public key of the first key-pair to determine the origin of the transmitted document, to verify the integrity of the transmitted document, and to establish a defense against repudiation of the transmission. If the sender time-stamps the document, the first terminal can also read the time stamp, and thus establish a defense against temporal repudiation. That is, the first terminal 110 determines that the transmitted document originated from a digital scanner 102 with an installed first key-pair private key. Typically, only a single digital scanner will have the private key of the first key-pair installed.

The first terminal 110 verifies that the transmitted document has not been modified during transmission. If the document was modified, the decrypted signature will not match the one-way hash function. The first terminal 110 includes a memory 116 for saving a copy of the transmitted document and the transmitted first signature as proof that the transmitted document was received. The stored document and signature act as proof that a transmission was received from the digital scanner 102.

In some aspects of the system 100, the digital scanner 102 includes a sentry 118 with installed user identity tests. A user identity test is a means of securely identifying users of the system 100. Every user identity test is associated with a corresponding terminal. In some aspects of the system 100, the user can have more than one account, where all the accounts are associated with the same terminal. In other aspects, each account is associated with a different terminal. Each account may have its own user identity test, or one test may be used for each of the accounts. Alternately, each user identity can be associated with a particular user who directs transmissions from the scanner 102 to a terminal(s) selected by that user. For example, a first user identity test is installed that is associated with the first terminal 110 and a second user identity test is associated with the second terminal 114. The user identity tests can be a PIN number that is known only to the user of the corresponding terminal. Smart cards and biometric data are other recognition criteria that could be used, to name but a few other examples of means that can be used to identify users of the digital scanner 102.

The digital scanner 102 includes a user interface 120 to accept a proof of user identity. For example, a keypad user interface 120 accepts a PIN number or a card reader interface 120 reads a magnetic strip. The digital scanner 102 transmits the scanned document and first signature to a first network-connected terminal 110 in response to the sentry 118 accepting the first user identity proof input at the interface 120.

The system 100 works as intended if the private key in the repository 104 cannot be accessed by the users. To allow user to modify or change the key would be to defeat an important aspect of the invention. Typically, the private key is installed at the factory and can only be accessed by personnel with high levels of security, such as the system administrator. The digital scanner sentry 118 can also be used to prevent non-authorized access to the repository 104 storing the private key of the first key-pair. Typically, the user identity tests are also installed at the factory or otherwise set up for the personnel having higher security.

A means must exist for publishing the public key of the first key-pair for use by the terminals 110/114. In some aspects of the system, the digital scanner 102 sends the public key of the first key-pair to the first terminal 110 in response to establishing the first user identity test in the sentry 118. In this scenario, the first terminal address is supplied when the user identity test is installed in the sentry 118, or when a user is assigned a predetermined test. For example, the user submits a terminal address and is assigned a PIN number. Then, the public key is mailed to the corresponding terminal. Alternately, the user supplies their terminal address the first time they attempt a transmission for the digital scanner 102.

As another public key publishing alternative, the system 100 optionally comprises a system store 122 with a copy of the public key of the first key-pair and a port connected on line 108 for access to the public key copies. The first terminal accesses the system store 122 and downloads the public key into the first terminal repository 112 when it is needed.

In some aspects of the system 100, the digital scanner 102 broadcasts the scanned document and the first signature. The term broadcasting, as used herein, has several meanings. It is intended to mean the indiscriminate sending of the scanned document and signature to all terminals in the system. Alternately, broadcasting means the sending the scanned document and signature to a list of terminals selected by the user. Then, each terminal has a repository for the public key of the first key-pair and an input to accept the transmitted document and the transmitted first signature from the digital scanner 102. Each terminal uses the public key to authenticate the transmitted document.

The same process described above, to authenticate a transmitted document, can be extended to further communications in the system 100. For example, the first terminal 110 processes the transmitted document to create a processed document, following the authentication of the transmitted document. The first terminal 110 then signs the processed document with a private key of a second asymmetric key-pair to create a second signature, and transmits the processed document and second signature. The second terminal 114 has a repository 124 for a public key of the second key-pair and an input on line 108 to accept the transmitted document and the transmitted second signature from the first terminal 110. The second terminal 114 uses the public key to authenticate the transmitted document.

### FUNCTIONAL DESCRIPTION

There are many digital signature algorithms. Some of them are public-key algorithms with secret information to sign documents and public information to verify signatures. The present invention is applicable to all these public-key algorithms. A typical application of the invention is presented below.

The digital scanner has a distinct key burned into RAM at production time that is not accessible to the users. This key is the scanner's private key. The system administrator may acquire a longer key with the ability to overwrite the key in RAM, for example, to change the key at a periodic maintenance interval. In addition, there is another key that is retrievable by the user, the scanner's public key. This public key is generated at production time and is unique. The private key is used for signing scanned document. The user sets up an account on the scanner, for example, with the user's PC's IP address when a FTP connection exists. At this point the user's terminal can acquire the scanner's public key, a one-time setup. The user walks up to the scanner and scans a document. The scanner prompts the user for a PIN. The scanner signs the document with the scanner's private key, and sends the image to the user's terminal. The user's terminal has a resident application that is waiting for FTP transportation from the scanner. This application intercepts the file sent by the scanner. An application on the user's terminal is invoked, in response to the file arrival. The application verifies the document, against the scanner's public key. This guarantees that nobody altered the message in transit, or substituted a different one. Only the scanner can sign the message, because nobody else has the scanner's private key. The application can now do it's own processing on the document (OCR, image enhancements, etc.) and sign it using the sender's private key. The application emails the document to another (second) terminal. The receiver at the second terminal gets the signed document and can verify the origin of the document, by verifying the document against the sender's public key.

To set up the system, each sender (terminal or scanner) must generate a key-pair and publish the public key. The user of the scanner must obtain the scanner's public key and setup an account with the scanner that includes supplying user's terminal address. A recipient must obtain the sender's public key, to be able to verify the received documents. This is done either directly (Email from sender), or by looking up the sender on a key server on the Internet.

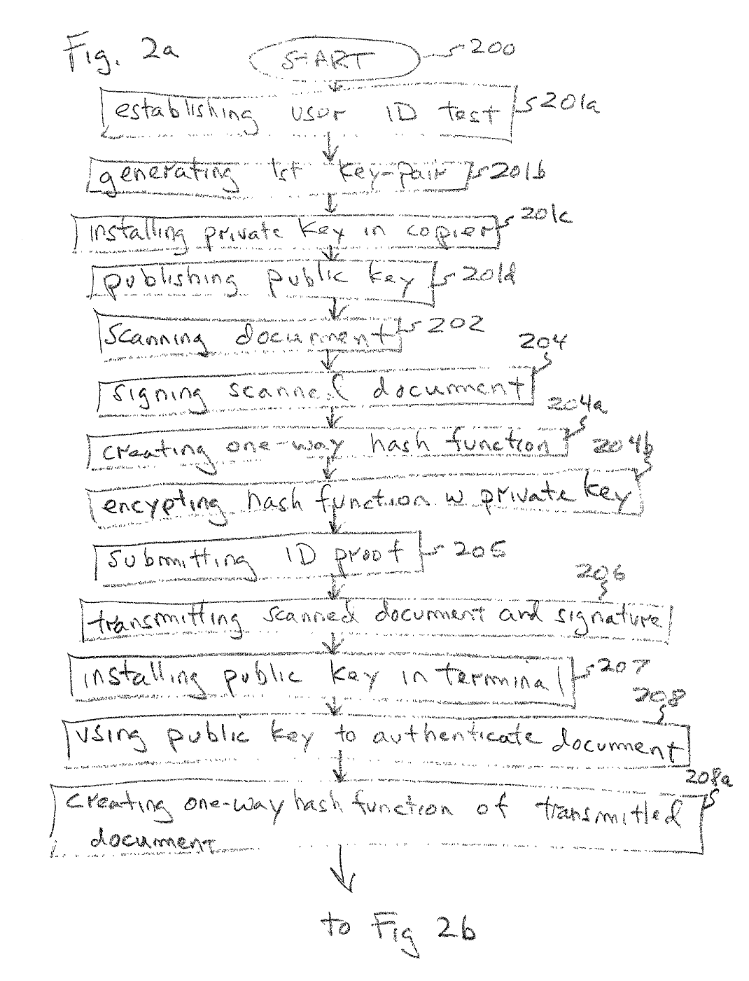

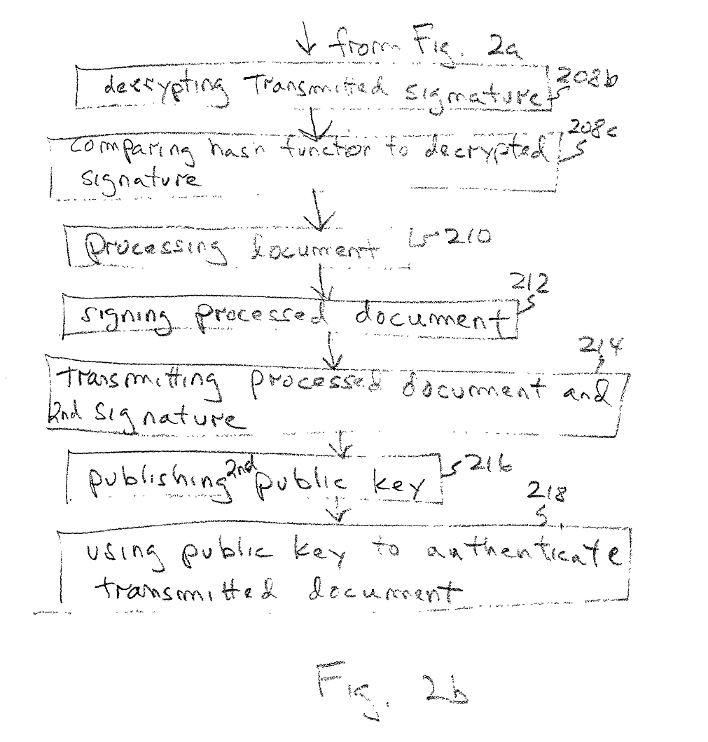

FIGS. 2a and 2b are flowcharts illustrating the present invention method for authenticating data transmission between a network-connected digital scanner and a terminal. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 200. Step 202 scans a document at a digital scanner. Step 204 signs the scanned document with a private key of a first asymmetric key-pair to create a first signature. Step 206 transmits the scanned document and first signature to a first network-connected terminal. Step 208, at the first terminal, uses a public key of the first key-pair to authenticate the transmitted document.

In some aspects, signing the scanned document with a private key of a first asymmetric key-pair to create a first signature includes substeps. Step 204a creates a one-way hash function of the scanned document. Step 204b encrypts the one-way hash function with the private key. Likewise, using a public key of the first key-pair to authenticate the transmitted scanned document in Step 208 includes substeps. Step 208a creates a one-way hash function of the transmitted document. Step 208b decrypts the transmitted first signature with the public key. Step 208c compares the one-way hash function of the transmitted document to the decrypted signature. Alternately, signing the scanned document with a private key of a first asymmetric key-pair to create a first signature in Step 204 includes encrypting the scanned document with the private key. Then, Step 208 would decrypt the transmission with the public key to both authenticate and recover the document.

Using a public key of the first key-pair to authenticate the transmitted document in Step 208 includes determining the origin of the transmitted document, verifying the integrity of the transmitted document, reading a time stamp, and establishing a defense against repudiation of the transmission. Determining the origin of the transmitted document includes determining that the transmission originated from a digital scanner with an installed first key-pair private key. Verifying the integrity of the transmitted document includes verifying that the scanned document has not been modified during transmission. Establishing a defense against repudiation of the transmission includes saving a copy of the transmitted document and the transmitted first signature as proof that the transmitted document was received.

Some aspects of the method include further steps. Step 201a establishes a first user identity (ID) test associated with the first terminal, at the digital scanner. Step 205 submits proof, at the digital scanner, of the first user identity when the scanned document is to be transmitted. Then, transmitting the scanned document and first signature to a first network-connected terminal in Step 206 includes transmitting to the first terminal in response to passing the first user identity test.

Step 201b generates the first key-pair with the private key and the public key. Step 201c non-accessibly installs the private key in the digital scanner. Step 201d publishes the public key. Step 207 installs the public key in the first terminal.

The public key can be published in Step 201d in a variety of means. For example, the public key can be loaded in a system repository that is accessed by the first terminal during the installation occurring in Step 207. Alternately, the public key is sent to the first terminal in response to establishing the first user identity test at the digital scanner. In other aspects, the terminal address is supplied when the user identity test is established, but is sent along with the initial transmission to the terminal.

In some aspects, transmitting the document to a first network-connected terminal in Step 206 includes transmitting the document to a plurality of network-connected terminals. Then, using a public key of the first key-pair to authenticate the transmitted document in Step 208 includes using the public key to authenticate the transmitted document at each terminal.

Some aspects of the method include further steps. Following the use of the public key of the first key-pair to authenticate the transmitted document in Step 208, Step 210 processes the transmitted document at the first terminal to create a processed document. Step 212 signs the processed document with a private key of a second asymmetric key-pair to create a second signature. Step 214 transmits the processed document and second signature to a second network-connected terminal. Step 216 publishes a public key of the second key-pair. Step 218, at the second terminal, uses the public key of the second key-pair to authenticate the transmitted document (as described above with the first terminal in Step 208).

A system and method have been provided for authenticating documents transmitted from a network-connected scanner. Examples are given of providing a signature for verification. Other embodiments not discussed could address additional encryption for the transmitted document itself. Neither is the invention limited to the particular asymmetric key mechanisms, copying devices, or the terminal types mentioned above. Other variations and embodiments of the invention will occur to those skilled in the art.

We claim:

1. A method for authenticating data transmission between a network-connected digital scanner and a terminal, the method comprising:
scanning a document at a digital scanner;
signing the scanned document with a private key of a first asymmetric key-pair to create a first signature;
transmitting the scanned document and first signature to a first network-connected terminal; and,
at the first terminal, using a public key of the first key-pair to authenticate the transmitted document.

2. The method of claim 1 wherein signing the scanned document with a private key of a first asymmetric key-pair to create a first signature includes:
creating a one-way hash function of the scanned document; and,
encrypting the one-way hash function with the private key; and,
wherein using a public key of the first key-pair to authenticate the transmitted scanned document includes:
creating a one-way hash function of the transmitted document;
decrypting the transmitted first signature with the public key; and,
comparing the one-way hash function of the transmitted document to the decrypted signature.

3. The method of claim 2 wherein using a public key of the first key-pair to authenticate the transmitted document includes:
determining the origin of the transmitted document;
verifying the integrity of the transmitted document;
reading a time stamp; and,
establishing a defense against repudiation of the transmission.

4. The method of claim 3 wherein determining the origin of the transmitted document includes determining that the transmission originated from a digital scanner with an installed first key-pair private key.

5. The method of claim 3 wherein verifying the integrity of the transmitted document includes verifying that the scanned document has not been modified during transmission.

6. The method of claim 3 wherein establishing a defense against repudiation of the transmission includes saving a copy of the transmitted document and the transmitted first signature as proof that the transmitted document was received.

7. The method of claim 1 wherein signing the scanned document with a private key of a first asymmetric key-pair includes an action selected from the group including:
creating a one-way hash function of the scanned document and encrypting the one-way hash function with the private key; and,
encrypting the scanned document with the private key.

8. The method of claim 2 further comprising:
at the digital scanner, establishing a first user identity test associated with the first terminal;
at the digital scanner, submitting proof of the first user identity when the scanned document is to be transmitted; and,
wherein transmitting the scanned document and first signature to a first network-connected terminal includes transmitting to the first terminal in response to passing the first user identity test.

9. The method of claim 8 further comprising:
generating the first key-pair with the private key and the public key;
non-accessibly installing the private key in the digital scanner;
publishing the public key; and,
installing the public key in the first terminal.

10. The method of claim 9 wherein publishing the public key includes an action selected from the group including loading the public key in a system repository accessible to the first terminal and sending the public key to the first terminal in response to establishing the first user identity test at the digital scanner.

11. The method of claim 2 wherein transmitting the document to a first network-connected terminal includes transmitting the document to a plurality of network-connected terminals; and,
wherein using a public key of the first key-pair to authenticate the transmitted document includes using the public key to authenticate the transmitted document at each terminal.

12. The method of claim 2 further comprising:
following the use of the public key of the first key-pair to authenticate the transmitted document, processing the transmitted document at the first terminal to create a processed document;
signing the processed document with a private key of a second asymmetric key-pair to create a second signature;
transmitting the processed document and second signature to a second network-connected terminal;
publishing a public key of the second key-pair; and,
at the second terminal, using the public key of the second key-pair to authenticate the transmitted document.

13. A system for authenticating data transmission, the system comprising:
a digital scanner having a repository for a private key of a first asymmetric key-pair and an interface for receiving documents, the digital scanner scanning a submitted document, signing the scanned document with the private key to create a first signature, and transmitting the scanned document and first signature at an output; and,
a first terminal having a repository for a public key of the first key-pair and an input to accept the transmitted document and the transmitted first signature from the digital scanner, the first terminal using the public key to authenticate the transmitted document.

14. The system of claim 13 wherein the digital scanner creates the first signature by generating a one-way hash function of the scanned document and encrypts the one-way hash function with the private key; and,
wherein the first terminal authenticates the transmitted scanned document by creating a one-way hash function of the transmitted document, decrypting the transmitted first signature with the public key, and comparing the one-way hash function of the transmitted document to the decrypted signature.

15. The system of claim 14 wherein the first terminal uses the public key of the first key-pair to determine the origin of the transmitted document, to verify the integrity of the transmitted document, to read a time stamp, and to establish a defense against repudiation of the transmission.

16. The system of claim 15 wherein the first terminal determines that the transmitted document originated from a digital scanner with an installed first key-pair private key.

17. The system of claim 15 wherein the first terminal verifies that the transmitted document has not been modified during transmission.

18. The system of claim 15 wherein the first terminal includes a memory for saving a copy of the transmitted document and the transmitted first signature as proof that the transmitted document was received.

19. The system of claim 13 wherein the digital scanner signs the scanned document with an action selected from the group including:
creating a one-way hash function of the scanned document and encrypting the one-way hash function with the private key; and,
encrypting the scanned document with the private key.

20. The system of claim 14 wherein the digital scanner includes a sentry with an installed first user identity test associated with the first terminal and an interface to accept a proof of user identity, and wherein the digital scanner transmits the scanned document and first signature to a first network-connected terminal in response to the sentry accepting the first user identity proof.

21. The system of claim 20 wherein the digital scanner sentry prevents non-authorized access to the repository storing the private key of the first key-pair.

22. The system of claim 21 wherein the digital scanner sends the public key of the first key-pair to the first terminal in response to establishing the first user identity test in the sentry.

23. The system of claim 21 further comprising:
a system store with a copy of the public key of the first key-pair and a port for access to the public key copies; and,
wherein the first terminal accesses the system store and downloads the public key into the first terminal repository.

24. The system of claim 14 wherein the digital scanner broadcasts the scanned document and the first signature; and,
the system further comprising:
a plurality of terminals, each terminal having repository for the public key of the first key-pair and an input to accept the transmitted document and the transmitted first signature from the digital scanner, each terminal using the public key to authenticate the transmitted document.

25. The system of claim 14 wherein the first terminal, following the authentication of the transmitted document, processes the transmitted document to create a processed document, signs the processed document with a private key of a second asymmetric key-pair to create a second signature, and transmits the processed document and second signature; and,
the system further comprising:
a second terminal having a repository for a public key of the second key-pair and an input to accept the transmitted document and the transmitted second signature from the first terminal, the second terminal using the public key to authenticate the transmitted document.
